(19) United States
(12) Patent Application Publication
(10) Pub. No.: US 2006/0131861 A1
(43) Pub. Date: Jun. 22, 2006

(54) Automotive knee bolster installation and method of construction

(76) Inventor: Ayyakannu Mani, Troy, MI (US)

Correspondence Address: JOHN R. BENEFIEL, 280 DAINES ST., #100 B, BIRMINGHAM, MI, 48009, US

(21) Appl. No.: 11/190,693

(22) Filed: Jul. 26, 2005

Related U.S. Application Data
(63) Continuation-in-part of application No. 10/683,173, filed on Oct. 10, 2003.
(60) Provisional application No. 60/417,431, filed on Oct. 10, 2002.
(60) Provisional application No. 60/607,382, filed on Sep. 3, 2004.

(51) Int. Cl. B60R 21/045

(52) U.S. Cl. 280/752; 280/751

(57) ABSTRACT

A knee bolster installation for an automotive vehicle having a knee impact absorber structure attached behind each end of a bridge plate, and each knee impact absorber structure having diverging front and back sides, a curved top and a curved intermediate web extending between the front and back sides, and a curved bottom connecting the lower end of front and back sides together. A horizontal stabilizer web connects the top side and intermediate web together to restrain bulging when crushed to avoid horizontal collapse thereof during deformation. Offset openings in each of the top side, intermediate web, and bottom side form wider curved strips at the inside adjacent the steering column space so that the front of the outside ends of the knee installation absorber structures are inclined away from the steering column space when deformed by knee impact.

### CROSS REFERENCE TO RELATED APPLICATION

This application is a continuation-in-part of U.S. Ser. No. 10/683,173 filed on Oct. 10, 2003, which claims the benefit of U.S. provisional Ser. No. 60/417,431, filed Oct. 10, 2002. This application also claims the benefit of U.S. provisional application Ser. No. 60/607,382 filed on Sep. 3, 2004.

### BACKGROUND OF THE INVENTION

This invention concerns so called “knee bolsters”, which are structures installed in automotive vehicles forward of the driver's seat positioned to be engaged by the driver's knees if the person submarines below the steering wheel mounted air bag during a collision.

Knee bolsters sometimes employ crushable or deformable impact absorbing structures which restrain the driver by contact by his or her knees, the crushing of the structure absorbing the energy of the person's momentum over a range of deformation to lower the stress on the person's knees and the load transmitted to the thigh bone.

Deformable structure knee bolsters are designed to be crushed by the person as the person is decelerated by the collision in order to reduce or prevent injury to the person.

Another requirement is the prevention of damage to or interference with the steering column mechanism during crushing of the knee bolster impact absorbing structure so as to allow the steering column to steer axially and absorb the upper body impact and to allow steering control to be maintained after a collision, if possible.

Costs are always a problem in automotive design, and the knee bolsters have sometimes been assembled from a number of components, representing an assembly cost.

Large aluminum sections have been proposed to be extruded to eliminate assembly costs, with portions cut out from the large extrusions. Large extrusions are themselves costly such that these structures are still somewhat expensive to manufacture.

Other knee bolsters have involved crush cells which have curved webs which are deformed, but such webs have a geometry which results in a buckling collapse of the web, greatly reducing the structure's ability to absorb energy. This can result in a great reduction in the restraining resistance of the structure. Such collapse can also produce gross bulging which can interfere with proper operation of the steering mechanism. Also, such a collapse mode can cause the surface impacted by the knees to directly hit the steering column and hinder the proper functioning of the steering column.

It is the object of the present invention to provide a deformable structure type knee bolster which is low in cost yet reliably providing adequate resistance to deformation over a range of crushing movement and prevents the development of any interference with the steering column mechanism.

### SUMMARY OF THE INVENTION

The above objects and others which will become apparent upon a reading of the following specification and claims are achieved by a knee bolster comprised of a right and left laterally spaced knee impact absorber deformable structures fixed on a respective side of the steering column by a knee engagement plate bridging the space between the knee structures.

Each knee impact absorber structure is a section extruded from plastic, aluminum or other extrudable material comprised of an outer wall having generally planar front and back sides extending in a generally V-shape , with the lower end of the divergent front side and a back side connected by a curved bottom. A double curved top connects the upper ends of the front and back sides. A vertical stabilizer web connected to the double curved top wall extends down to an intermediate double curved web extending between the back and front sides at an intermediate height. A series of openings are cut into the top, intermediate, and bottom sides to create inner and outer strips.

This geometry creates an upper stabilizer comprised of a pair of crush cells having curved top and bottom sets of strips connecting each of the upper part of the back and front sides of the structure to a respective side of the horizontal stabilizer web.

A lower stabilizer is formed by the curved bottom strips and the lower part of the back and front sides.

The left and right knee impact absorber structures are connected to either end of a separately formed flat bridge plate which is located at the front of the bolster to be engaged by the driver's knees when a collision occurs.

Sets of inner strips adjacent a space through which the steering column passes are wider than outer strips adjacent the outer side, the slope outwardly away from the steering column so that the front and back walls are collapsed together at their outer sides when the knees force the bridge plate to bend to deform the knee impact absorber structures, creating a wedge shape guiding the knees away from the center and avoiding the intrusion of any part of the deformed knee structures into the area where the steering column passes.

Outward buckling collapse of the outer strips is prevented by the restraining effect of the upper stabilizer web so that resistance to deformation is sustained throughout the crush event.

In other embodiments, each knee impact absorber structure is comprised of slightly angled, nearly parallel straight outer front and back side walls defining a space subdivided into cells bypartitions comprised of a parallel intermediate web, curved webs and end walls. Openings can be formed in the partitioning walls to control the crush strength of the structure. Grooves extending across the inner surface of the walls can also be included for this purpose.

In still other embodiments, individual cell walls are attached to each other as by spot welding to create a multi-cell knee impact absorber structure.

### DESCRIPTION OF THE DRAWINGS FIG. 1 is a pictorial view of a complete knee bolster installation according to the invention.

FIG. 1 A is an exploded pictorial view of the knee bolster installation shown in FIG. 5.

FIG. 2 is an enlarged pictorial view of the left knee impact absorber structure used in the knee bolster according to the invention.

FIG. 3A is a side view of the knee impact absorber structure shown in FIG. 2.

FIG. 3B is a top view of the knee impact absorber structure shown in FIG. 2.

FIG. 3C is a front view of the knee impact absorber structure shown in FIG. 2.

FIG. 4 is a pictorial view of a preform used to construct the knee impact absorber structure shown in FIG. 2.

FIG. 5A is a side view of the preform shown in FIG. 4.

FIG. 5B is a top view of the preform shown in FIG. 4, with an indication of the angle from front to rear of the inner side thereof.

FIG. 5C is a front view of the preform shown in FIG. 4.

FIG. 6A is a diagram showing a side view of one of the knee impact absorber structures and a juxtaposed knee of the driver prior to impact.

FIG. 6B is a diagram according to FIG. 6A depicting the after deformed condition of the knee impact absorber structure.

FIG. 7A is a plan view diagram of the knee bolster according to the invention depicting a driver's knee and the steering column prior to impact.

FIG. 7B is a diagram according to FIG. 7A depicting the after impact condition of the knee impact absorber structure.

FIG. 8 is a diagrammatic depiction of the after impact condition of the knee impact absorber structure if the horizontal stabilizer web is omitted.

FIG. 9 is a pictorial view of a first alternate embodiment of a knee impact absorber structure according to the invention.

FIG. 10 is a pictorial view of a second embodiment of a knee impact absorber structure according to the invention.

FIG. 11 is a pictorial view of a third alternate embodiment of a knee impact absorber structure according to the invention.

FIG. 12 is a pictorial view of a fourth alternate embodiment of a knee impact absorber structure according to the invention.

FIG. 13 is an end view of the embodiment of the knee impact absorber structure shown in FIG. 12.

FIG. 14 is an enlarged fragmentary view of a portion of the structure shown in FIG. 13.

FIG. 15 is a pictorial view of a fifth alternate embodiment of a knee impact absorber structure according to the invention.

FIG. 16 is a pictorial view of a fifth alternate embodiment of a knee impact absorber structure according to the invention.

FIG. 17 is a pictorial view of a fifth alternate embodiment of a knee impact absorber structure according to the invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

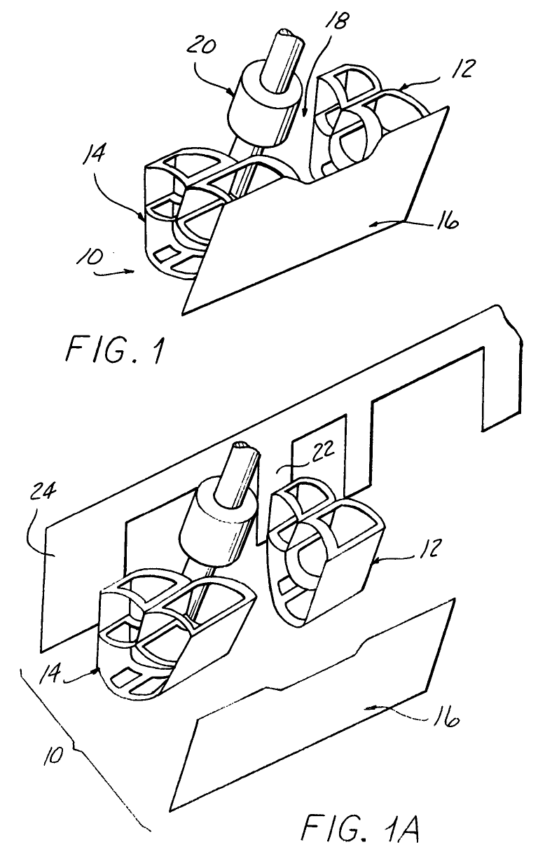

Referring to the drawings, and particularly FIGS. 1 and 1A, the knee bolster 10 according to the present invention includes a right knee impact absorber structure 12 and a left knee impact absorber structure 14, both attached to a respective end of a bridging plate 16 extending between the driver's seat and the structures 12 and 14 and facing the driver's knees. A space 18 between the absorber structures 12, 14 accommodates the steering column 20 of the vehicle in which the knee bolster 10 is installed.

The absorber structures 12 and 14 are each restrained by vehicle body structure 22, 24 depicted diagrammatically forward of the knee bolster 10.

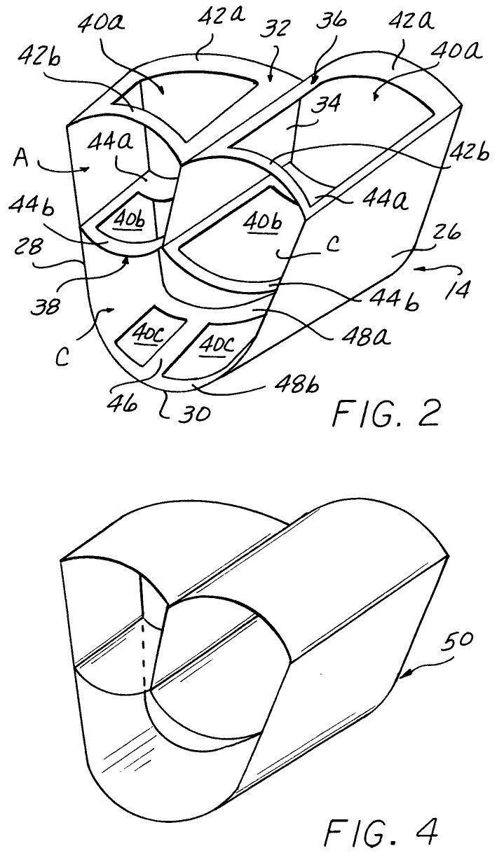

FIG. 2 shows details of the left knee impact absorber structure 14. The knee impact absorber structures 12 and 14 need not be identical, as differing crush characteristics thereof are sometimes necessary or desirable, but are contemplated as having the same general configuration according to the present invention.

The left impact absorber structure 14 has a wider front side 26 and a narrower back side 28 which diverge from each other in the direction towards their upper ends. The lower ends thereof are connected together by a curving bottom wall 30.

At their upper ends, the front and back sides 28, 30 are connected together by a top wall 32 having two curved segments. A horizontal stabilizer web 34 extends vertically down from the joint 36 between the curve segments of the top wall 32 to an intermediate wall 38, also having two curved segments forming a pair of connected upper crush cells A and B. Each of the top, intermediate and bottom walls 32, 38, 30 are pierced and cut to form pairs of openings 40a, 40b, 40c, therein. These openings can be of any shape and can incorporate rounded corners.

These openings are offset to the left to create outwardly curved top side strips 42a at the right side of adjacent the space 18 which are wider than similar intermediate curved strips 42b at the left.

Intermediate curved strips 44a, 44b are formed in the intermediate wall 38 by openings 40b, with right side strips 44a adjacent the space 18 wider than the left side strips 44b.

A lower crush cell C is formed by the outwardly curved bottom wall 30, the lower portions of the front and back sides 28, 30, and the curved strips 44.

A strip 46 between the openings 40c provides a stabilizer function for bottom curved side strips 46a, 46b.

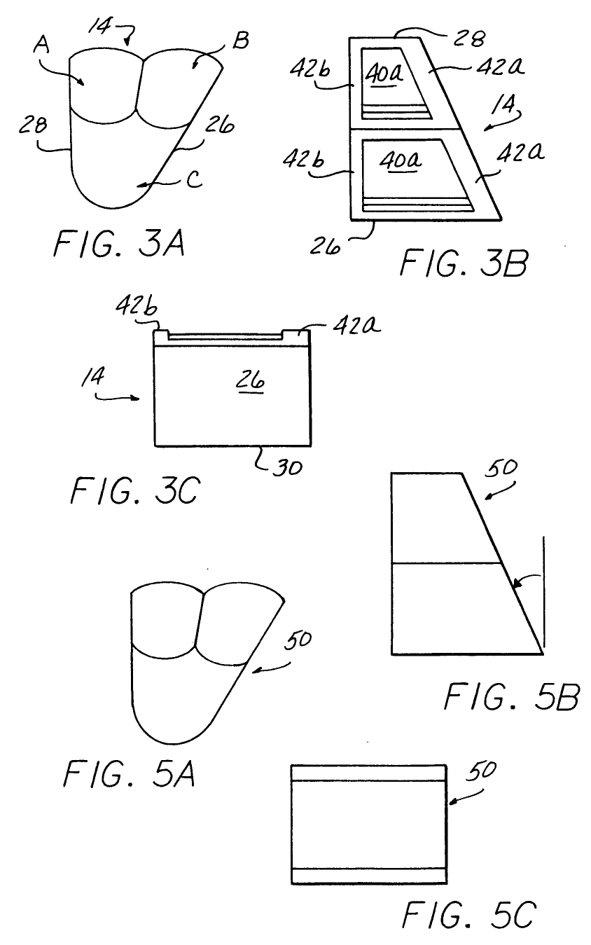

As best seen in FIG. 3b, the inner side, closest to the space 18, is angled so that the front wall 26 is substantially wider than the back wall 28.

FIGS. 4 and 5A-5C show a preform 50 from which the knee impact absorber structures 12, 14 can be made from an extrusion, and by piercing or drilling or cutting (laser beam, water jet, for example) the various openings, and cutting the angled inside as indicated in FIG. 5B.

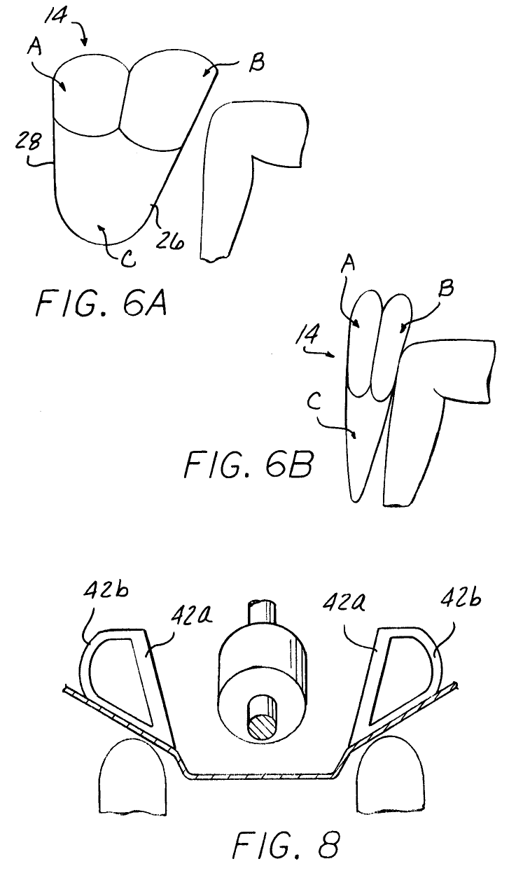

FIG. 6A and 6B show the controlled deformation of the left and right knee impact absorber structures 12 and 14 occurring during a knee impact event, with the angled front and rear sides 26, 28 swinging together to crush the A, B, and C cells, the curved strips 42, 44, 48 bowing together.

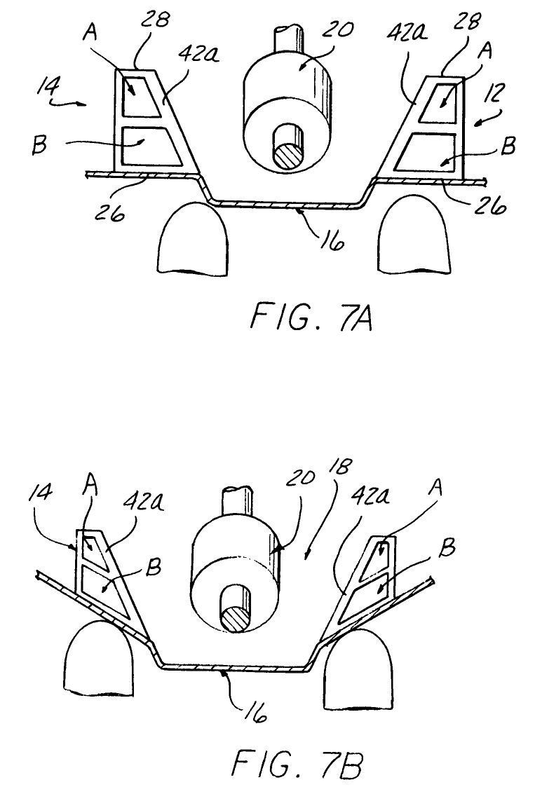

FIGS. 7A and 7B show from the top further details of the exact mode of crush of the upper cells A, B.

The outer end of the front walls 26 pushed back by deformation of the attached portion of the bridge plate 16.

This creates an outwardly angled surface guiding the driver's knees away from the steering column space 18. The wider inside strips 42a, 44a, 48a restraining deformation thereof to create the angled deformation shown.

The stabilizer webs 34, 46 restrain outward bulging of the strips 42b, 44b, 48b to prevent collapse which would otherwise occur, as shown in FIG. 8 without the stabilizer webs. This insures a controlled resistance through the range of deformation without a buckling collapse which if occurring would limit the absorption of the kinetic energy of the driver.

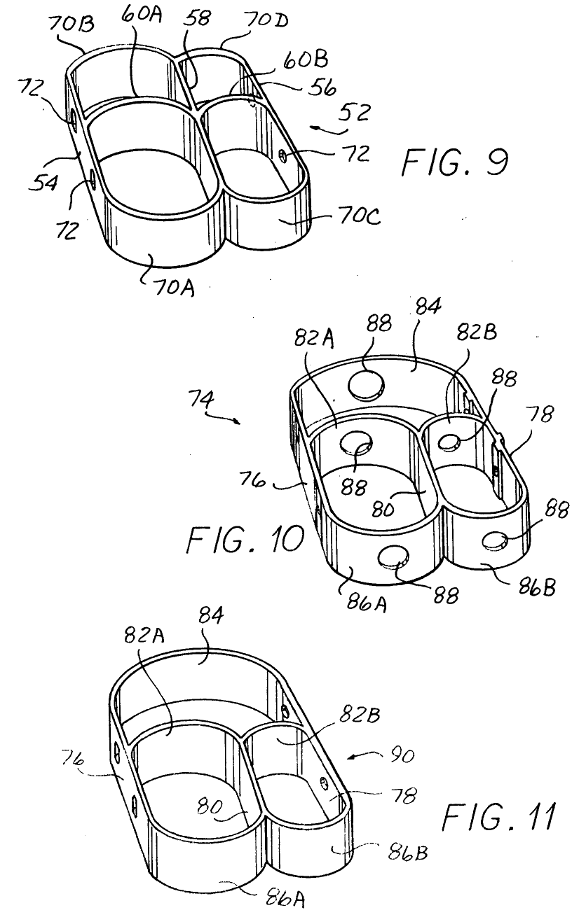

FIG. 9 shows a first alternate embodiment 52 of a knee impact absorber structure comprised of slightly angled, nearly parallel straight front and back side walls 54, 56 defining an interior space and a parallel intermediate web 58 and curved end webs 60A, 60B and end walls 70A, 70B, 70C, and 70D. Suitable mounting holes 72 are provided. This produces four cells of different sizes.

FIG. 10 shows a second alternate embodiment of a knee impact absorber 74 also having nearly parallel front and back side walls 76, 78 defining an interior space and subdivided into three cells by an interior parallel web 80 shorter than the full height of the structure. Curved webs 82A, 82B are provided with curved end walls 84 and 86A, 86B completing the three cells.

Weakening holes 88 can be formed with curved webs 82A, 82BB and end walls 84, 86A, 86B to create a desired crush strength.

FIG. 11 shows a similar knee impact absorber structure 90 without the weakening holes.

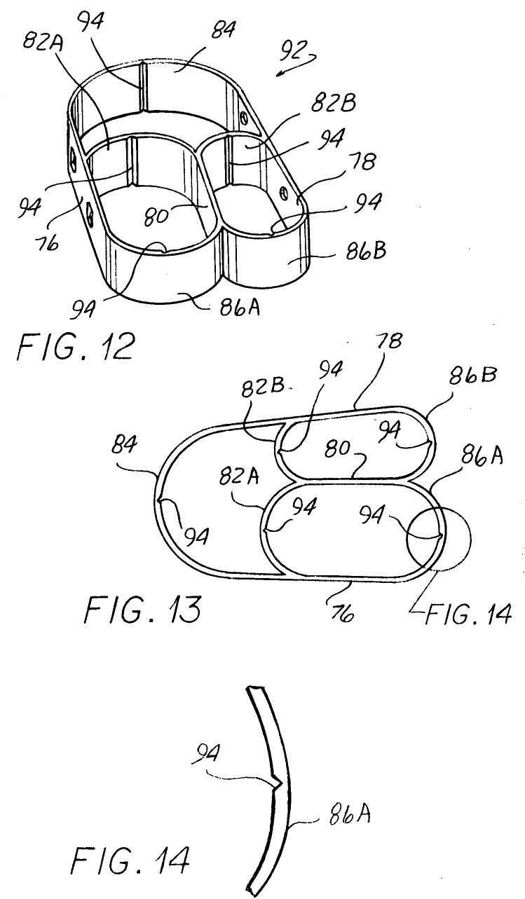

FIG. 12 shows a similar knee impact absorber structure 92 but formed with weakening grooves 94 extending across the width of the inner surface of the curved end walls 84, 86A, 86B, and curved webs 82A, 82B of a depth and width selected to produce a desired overall crush strength.

Thus, a simple low cost but quite effective knee bolster installation is provided.

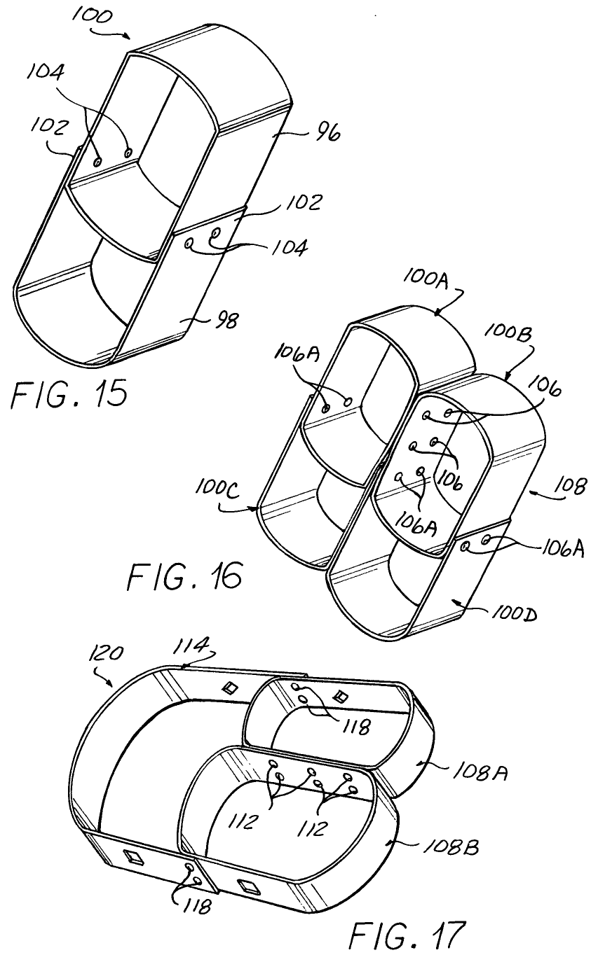

FIGS. 15-17 show an alternate construction.

In FIG. 15, an individual closed cell 96 is joined to a U shaped open cell 98 to form a two cell structure 100. This is accomplished by providing an overlap of the walls of the open cell 98 onto the sides of cell 96 at 102 with spot weld 104 joining the same together.

FIG. 16 shows two of the structures 100A, 100B fastened together by spot welds 106 joined adjacent side by side cells 100A, 100B. Two open cells 100C, 100D have legs overlapping the closed cell walls and are connected with spot welds 106A to form a cell structure 188.

FIG. 17 shows two single cells 100A, 100B of different size with spot welds 112 connecting adjacent walls together. A large open cell 114 has legs overlapping the outer walls of each of the cells and welds 116. Thus, a single large extension is not needed by a built up construction of small extruded or formed process connect the same to form a two cell structure 120. Welds 118 connect the cells 110A, 110B to cell 114 to create a three cell structure 120.

1. A vehicle knee bolster installation for an automotive vehicle comprising:
a bridging plate adapted to extend across a space accommodating a vehicle steering column, said bridging plate positioned facing a driver's knees;
a pair of knee impact absorber structures each attached to said bridging plate and interposed between said bridging plate and fixed vehicle structure forward of said steering column space;
each of said knee impact absorber structures comprising a front and a back side, said front side attached to said bridge plate, a curved top side connecting upper ends of said front and back sides; and
a curved bottom connecting bottom ends of said front and back sides, and a curved intermediate web connecting said front and back sides of each of knee impact absorber said structures at an intermediate location thereof to form a plurality of structure cells.

2. The knee bolster installation according to claim 1 further includes a horizontal stabilizer web located between said front and back sides and extending across the width thereof connecting said curved top side and said curved intermediate web to form two crush cells to restrain excessive bulging and collapse of said top side and intermediate web thereof upon impact.

3. The knee bolster installation according to claim 2 wherein said curved top side and intermediate panel are double curved, each having separate curved portions between said horizontal stabilizer web and said front and back sides respectively.

4. The knee bolster installation according to claim 2 wherein openings are formed in said top side, intermediate web, and bottom side forming curved strips therein adjacent each end thereof.

5. The knee bolster installation according to claim 4 wherein said openings are located so that curved strips adjacent said steering column space are wider than curved strips adjacent outside ends of said front and back sides of said knee installation absorber structure.

6. The knee bolster installation according to claim 1 wherein each of said knee installation absorber structures are wider in the front than the back thereof to have an angled shape.

7. The knee bolster installation according to claim 1 wherein each of said knee installation absorber structures are extruded from aluminum or any other metal.

8. The knee bolster installation according to claim 1 wherein each of said knee installation absorber structures are extruded from plastic.

9. The knee bolster installation according to claim 2 wherein said top side is curved upwardly and said bottom side is curved downwardly.

10. The knee bolster installation according to claim 1 wherein said front and back sides each slope outwardly from said connected bottom ends thereof.

11. The knee bolster installation according to claim 1 wherein at least one of said cells is formed as a closed cell and an open cell has legs overlapping sides of said closed cell and connected thereto to form a plurality of cells.

12. A method of constructing the knee bolster recited in claim 2 wherein said knee installation absorber structure are each extruded from an extrudable material.

13. A method of constructing the knee bolster recited in claim 4 wherein said knee installation absorber structures are each extruded from an extrudable material and said openings are thereafter cut into said curved top side, curved intermediate web and curved bottom.

14. A method of constructing the knee bolster recited in claim 1 further including grooves formed into inner surfaces at least of some of said sides and webs extending across the width thereof.
